(19) United States
(12) Patent Application Publication
(10) Pub. No.: US 2010/0047727 A1
(43) Pub. Date: Feb. 25, 2010

(54) METHOD OF REHEATING IN A FURNACE USING A FUEL OF LOW CALORIFIC POWER, AND FURNACE USING THIS METHOD

(75) Inventors: Rene-Vincent Chever, Brou Sur Chantereine (FR); Patrick Giraud, Paris (FR)

Correspondence Address: CONNOLLY BOVE LODGE & HUTZ LLP, 1875 EYE STREET, N.W., SUITE 1100, WASHINGTON, DC, 20006, US

(73) Assignee: FIVES STEIN, Ris Orangis (FR)

(21) Appl. No.: 12/440,520

(22) PCT Filed: Sep. 11, 2007
(86) PCT No.: PCT/FR07/01461

§ 371 Date: Aug. 27, 2009

(30) Foreign Application Priority Data
Sep. 13, 2006 (FR) FR 06 07999

(51) Int. Cl. F23L 15/02; F27B 3/26; F23D 11/44; F27D 17/00

(52) U.S. Cl. 431/11; 431/161; 431/215; 432/181; 432/182; 432/214; 432/30

(57) ABSTRACT

Method of controlling a reheat furnace (1) for reheating iron and steel products, for example slabs, blooms, ingots or billets, making it possible for the product to be reheated to be brought to the desired temperature for rolling, the furnace being equipped with a heat recuperator (A). The furnace is equipped mostly with regenerative-type burners which include regenerators and operate in on/off mode; the burners operate in time modulation mode; a portion of the combustion gases passes through the regenerators of the regenerative burners so as to preheat one of the fluids (either the fuel or the oxidizer) participating in the combustion; and the remainder of the combustion gases passes through the heat recuperator (A) in order to preheat the fluid (either the oxidizer or the fuel) other than that preheated in the regenerators.

The invention relates to a method of controlling a reheat furnace, in particular a furnace for reheating iron and steel products, for example slabs, blooms, ingots or billets, making it possible for the product to be reheated to be brought to the desired temperature for rolling, with a fuel having a low calorific value, commonly called a “lean gas”.

The term “lean gas” denotes a gaseous fuel whose calorific value is between 2700 kJ/Sm³ and 4000 kJ/Sm³.

These lean gases are generally composed of a large proportion of inert gases, such as nitrogen and carbon dioxide, which act as ballast and must be reheated in the combustion, and consequently limit the theoretical combustion temperature.

To give an example, the case of operation with a gaseous fuel having a low calorific value, taking as example blast furnace gas, will be described below in greater detail.

Blast furnace gas comes from a blast furnace where it is generated as a by-product of the pig iron smelting process. Its main advantage lies in the fact that it is available “free”, hence the benefit of utilizing it as fuel to feed the furnaces located on the iron and steelmaking site. However, it has a low calorific value, of around 3500 kJ/Sm³, owing to its chemical composition which comprises a high content of inert gases, namely N₂ and CO₂. In order for the products to be reheated to reach the required temperature for rolling upon discharge from the furnace, namely about 1150 to 1280° C., it is essential for the walls of the furnace and the combustion gases to be at high temperature, about 1300 to 1400° C. According to the prior art, such temperatures are difficult to achieve by the theoretical combustion temperature when using exclusively lean gases. The theoretical combustion temperature is the maximum temperature that can be obtained by the gases at the end of combustion. It is calculated by determining the final state of a fuel/oxidizer mixture taken initially in stoichiometric proportions or in defined proportions and having undergone an instantaneous adiabatic combustion at constant pressure and with no heat exchange with its environment. The theoretical combustion temperature cannot be obtained in a furnace since, on the one hand, the combustion never takes place instantly and, on the other hand, the flame always exchanges heat with its environment. As a result, under given conditions, it is in fact only possible to obtain a practical flame temperature below the theoretical temperature. The ratio of this practical temperature to the theoretical temperature is called the “pyrometric efficiency”. This notion is for example explained in detail in the article “Combustibles pauvres dans les fours continus de sidérurgie [Lean fuels in continuous iron and steelmaking furnaces] published in Revue Générale de Thermique, No. 232 in April 1981. The pyrometric efficiency of blast furnace gas is for example 0.80. This value is adopted for explaining the technical problem to which the invention provides a solution.

The flue gases present in the furnace therefore have a maximum temperature corresponding to the practical flame temperature.

It is known that a means of increasing the theoretical combustion temperature consists in preheating the combustion air or the fuel upstream of the nozzle of the burner.

The means employed according to the prior art consist in preheating one of the two fluids participating in the combustion, either through a recuperator located in the flue gas circuit or through regenerators of regenerative burners.

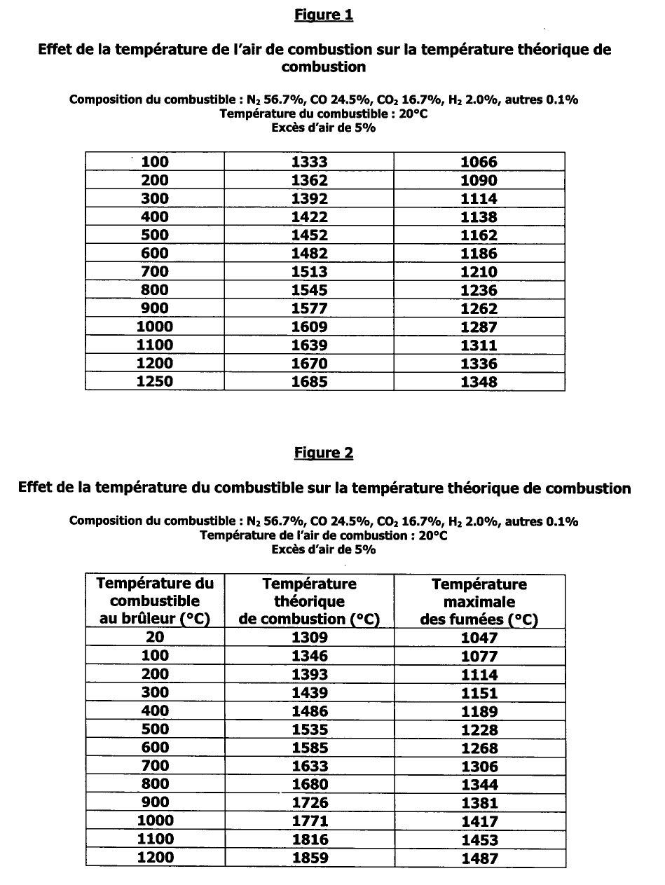

FIGS. 1 to 4 of the appended drawings are tables of values for a lean gas fuel of the blast furnace type, the composition of which by volume is the following: 56.7% N₂; 24.5% CO; 16.7% Co₂; 2.0% H₂ and 0.1% other gases. The conditions are indicated at the top of each table.

The calculated values indicated in FIG. 1 show that by preheating the combustion air, an air temperature of 1250° C. is not sufficient to obtain a flue gas temperature comparable to the temperatures obtained for rich gases, that is to say 1400° C. and higher. This level of air reheat temperature, and therefore a fortiori, a higher level, cannot be reached with an industrial recuperator located in the flue gas circuit.

Regenerative burners, thanks to which it is possible to reheat the air to high temperature, make it possible to obtain temperature differences of about 150° C. between the flue gases and the preheated gas. However, the limiting temperature for reheating the air with a regenerative burner lies between 1150° C. and 1200° C.

It is therefore not possible to obtain a furnace wall temperature sufficient to reheat a product to 1200° C. by preheating only the combustion air.

The calculated values indicated in FIG. 2 show that by preheating the lean gas, it is necessary to preheat it to a temperature of 1000° C. in order to obtain a flue gas temperature comparable to temperatures obtained (1400° C. and higher) for rich gases. This temperature level could be reached by carrying out the preheating in a regenerative burner. However, this solution is not employed on an industrial scale because of technical problems that make it difficult to implement it, such as the risks inherent to this gas temperature level and to the problems caused by the gas cracking at these temperatures. It is therefore not possible on an industrial scale to obtain a furnace wall temperature sufficient to reheat a product at 1200° C. by only preheating the lean gas.

Another means for increasing the theoretical combustion temperature consists in superoxygenating the combustion air, that is to say increasing its oxygen content.

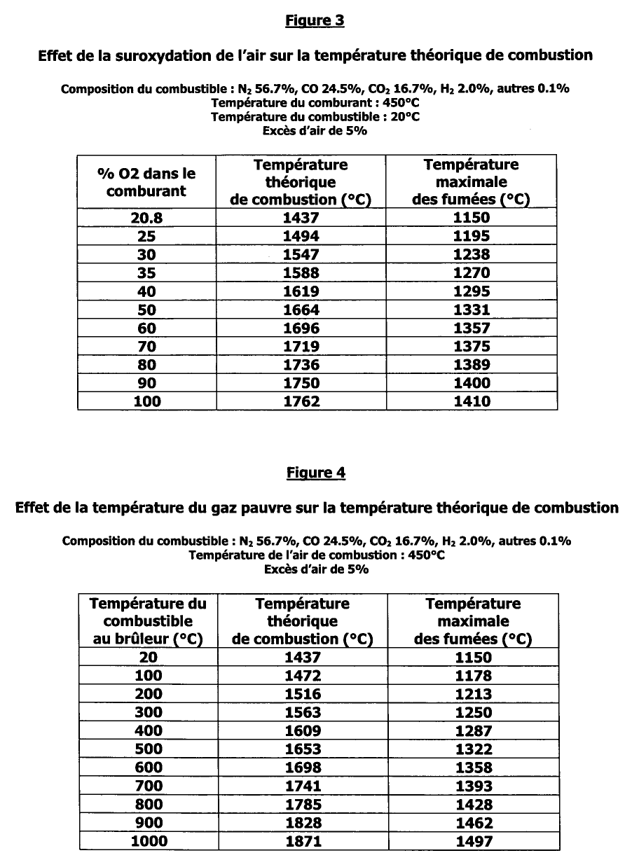

The calculated values indicated in FIG. 3, with an oxidizer at 450° C., show that this solution is unsatisfactory as even by preheating the oxidizer to 450° C., an oxygen content of 80% in the oxidizer is needed to achieve a flue gas temperature close to 1400° C. Preheating almost pure oxygen to this temperature is not carried out on an industrial scale for safety reasons. Moreover, the profitability of this solution would be very variable, depending on the plants and the cost of m³ of oxygen. For the same reasons, a lower oxygen content combined with preheating of the lean gas is not a satisfactory solution.

Thus, the solutions employed in the prior art are unable to bring the product to be reheated to the desired temperature for rolling with exclusively a fuel of low calorific value satisfactorily.

To solve this technical problem, the invention lies mainly in a method of controlling a reheat furnace, in particular a furnace for reheating iron and steel products, for example slabs, blooms, ingots or billets, making it possible for the product to be reheated to be brought to the desired temperature for rolling, the furnace being equipped with a heat recuperator, characterized in that:
the furnace is equipped mostly with regenerative-type burners which include regenerators and operate in on/off mode;
the burners operate in time modulation mode;
a portion of the combustion gases passes through the regenerators of the regenerative burners so as to preheat one of the fluids (either the fuel or the oxidizer) participating in the combustion; and
the remainder of the combustion gases passes through the heat recuperator in order to preheat the fluid (either the oxidizer or the fuel) participating in the combustion other than that preheated in the regenerators.

Advantageously, a lean gas is used exclusively as fuel, and preheating to high temperature one of the fluids participating in the combustion, obtained as it flows through the regenerators of the burners, is combined with preheating of the other fluid participating in the combustion, obtained as it flows through the heat recuperator, and makes it possible for the products leaving the furnace to have been reheated to the required temperature.

The flow rate of the flue gases passing through the regenerator of a regenerative burner is determined so as to obtain the desired temperature of the flue gases leaving the regenerative burner and correspondingly the desired temperature of the fluid to be preheated after it has passed through the regenerator.

Preferably, for a constant cycle time with switching between the two regenerative burners of any one pair of burners, the operating time of each regenerative burner in heater mode is adjusted for each cycle so that the burner transmits the required calorific value.

To achieve a sufficient flame temperature during the ignition phases of the furnace or when not operating at full capacity, the temperature of the fluid coming from the recuperator is advantageously maintained at a minimum level, either by using the furnace burner(s) located closest to this recuperator or by using one or more booster burners. Preferably, the booster burners are placed in the flue gas circuit upstream of the recuperator.

The proportion of flue gases passing through the heat recuperator is advantageously used for precisely controlling the pressure inside the furnace, so as to limit the intake of air.

Advantageously, the lean gas is preheated in the regenerators of the burners to a temperature between 600° C. and 800° C.; the lean gas has a calorific value of between 2700 kJ/Sm³ and 4000 kJ/Sm³; the oxidizer is formed by air preheated in the heat recuperator to a temperature between 400° C. and 600° C. in order to obtain a flue gas temperature above 1300° C., allowing the product to be reheated to reach a temperature between 1150° C. and 1280° C.

Preferably, the regenerative-type burners are placed on opposite sides of the furnace and are grouped in pairs of burners facing one another, the burner of one pair located on one side being controlled so as to operate as a burner and as a flue alternately, while the burner of the other pair located on the other side is controlled so as to operate as a flue and as a burner alternately. The number of regenerative-type burners is greater than the total number of burners of another type.

The constant cycle time with switching between the two regenerative burners of any one pair of burners is advantageously between 40 and 80 seconds and the operating time of each regenerative burner in heater mode is adjusted for each cycle so that the burner transmits the required calorific value.

The invention also relates to a reheat furnace for reheating iron and steel products, for example slabs, blooms, ingots or billets, making it possible for the product to be reheated to be brought to the desired temperature for rolling, which includes a heat recuperator, characterized in that it comprises:
on the one hand, mostly regenerative-type burners which include regenerators and operate in on/off mode;
means for making the burners operate in time modulation mode;
means so that a portion of the combustion gases passes through the regenerators of the regenerative burners so as to preheat one or other of the fluids participating in the combustion (either the fuel or the oxidizer); and
means so that the remainder of the combustion gases passes through the heat recuperator for preheating the fluid (either the oxidizer or the fuel) that is not preheated in the regenerators.

The invention consists, apart from the abovementioned provisions, of a number of other provisions which will be more explicitly explained below with regard to exemplary embodiments described in detail with reference to the appended drawings, which are however in no way limiting. In these drawings:

FIGS. 1 to 3 are tables of calculated values for a lean gas fuel of the blast furnace type, the composition of which by volume is the following: 56.7% N₂; 24.5% CO; 16.7% Co₂; 2.0% H₂; and 0.1% other gases, with operation according to the methods of the prior art;

FIG. 4 is a table of calculated values for a lean gas fuel of the blast furnace type similar to that of FIGS. 1 to 3, with operation according to the method of the invention;

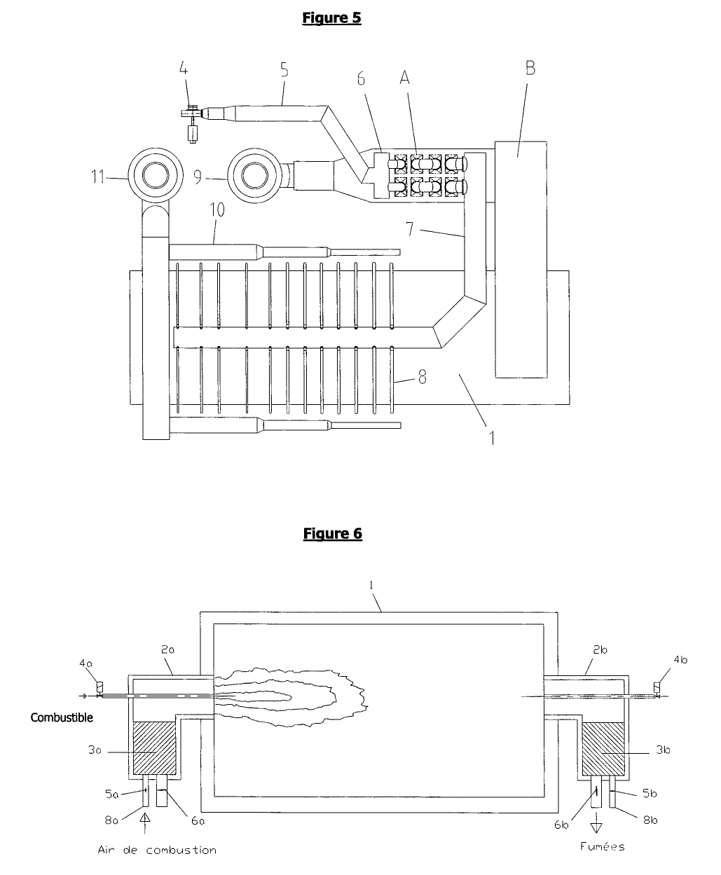

FIG. 5 is a schematic plan view of a reheat furnace according to the invention; and

FIG. 6 is a vertical cross section of the furnace of FIG. 5 through the two facing regenerative burners.

As an exemplary embodiment of the invention, the table in FIG. 4 shows that preheating the lean gas in the regenerator to a moderate temperature of 700° C. combined with preheating of the combustion air to 450° C. in the heat recuperator makes it possible to achieve the flame temperature required for reheating the products.

One feature of the method according to the invention is that the flue gases are distributed in two separate circuits making it possible to preheat, depending on the circuit, the fuel and the oxidizer, and that at least one of these flue gas circuits passes through a recuperator draining heat from the flue gases output by the furnace.

Another feature of the method according to the invention is that the combination of preheating one of the fluids participating in the combustion, obtained as it flows through the regenerators of the burners, and of preheating the other fluid participating in the combustion, obtained as it flows through the heat recuperator, makes it possible, thanks to a high flame temperature, for the products to be reheated to reach the required temperature on leaving the furnace using exclusively a lean gas.

Another feature of the method according to the invention is that the flow rate of the flue gases that pass through the regenerator of a regenerative burner is determined so as to obtain the desired flue gas temperature at the outlet of the regenerative burner and correspondingly the desired temperature in the fluid to be preheated after it has flowed through the regenerator.

This is because, to achieve the intended flame temperature with a lean gas according to the invention, the oxidizer and the fuel are preheated. In order for the fluid to be preheated to reach the required temperature on leaving the regenerator, it is necessary for the latter to be able to transmit the corresponding calorific energy to said fluid. This is possible if the regenerator has reached a sufficient temperature during the preceding operation of the burner in flue mode. Specifically, for a given regenerator mass, this temperature corresponds to a quantity of energy stored in the regenerator capable of being transferred to the fluid to be preheated upon flowing through the regenerator during the next operation of the burner in heater mode.

According to this feature of the invention, the flow rate of the flue gases flowing through the regenerator during operation in flue mode is limited to that needed to reach the intended temperature on the regenerator. The flow of excess flue gases is removed to the outside of the furnace by passing through the tubular heat recuperator preheating the other fluid participating in the combustion, thus contributing to a good overall thermal efficiency of the furnace.

Another feature of the method according to the invention is that, for a constant cycle time with switching between the two regenerative burners of any one pair of burners, the operating time of each regenerative burner in heater mode is adjusted for each cycle so that the burner transmits the required calorific value.

The operating cycle time of a burner comprises the operating time in heater mode to which the operating time in flue mode is added. For a constant cycle time, a reduction in the operating time in heater mode, because of a lower heat demand, is reflected in an increase in the actual operating time in flue mode. Owing to this longer operating time of the burner in flue mode, the flow of flue gases flowing through the regenerator is reduced so as to limit the amount of energy stored in the regenerator to that needed for the fluid to be preheated during the next operation of the burner in heater mode. Again, the flow of excess flue gases is removed to the outside of the furnace, passing through the tubular heat recuperator preheating the other fluid participating in the combustion, thus contributing to good overall thermal efficiency of the furnace.

According to one exemplary embodiment of the invention, the constant cycle time of a burner is 60 s (60 seconds) with a base operating time in heater mode of 30 s and an operating time in flue mode of 30 s. When the calorific value required for the burner is 100% of its nominal value, the burner operates for 30 s in heater mode and then 30 s in flue mode. When the calorific value required for the burner is 50% of its nominal value, the burner operates for 15 s in heater mode and then 45 s in flue mode. Since a certain amount of time is needed to bring the burner into service in heater mode, there is a minimum operating time in heater mode, for example 5 s. Depending on the heat demand, the operating time in heater mode will thus be between 5 and 30 s, each second at least of the heating time adding one second to the operating time in flue mode for a constant cycle time of 60 s.

Another feature of the method according to the invention is that the proportion of flue gases passing through the tubular heat recuperator is advantageously used for precisely controlling the pressure inside the furnace so as to limit the intake of air. According to the invention, the flow of flue gases discharged by the burners through the regenerators is limited. This results in a larger amount of flue gases present in the furnace used advantageously to control the pressure level of the furnace, by acting on the rate of extraction of the flue gases through a register or an exhauster, the electric motor of which is controlled via the frequency changer, for changing the frequency of the supply current.

FIG. 5 illustrates an exemplary embodiment to the invention, showing the installation of a heat recuperator A, for example a tubular heat recuperator, placed outside the furnace 1 in the flue B. The preheating of the combustion air and/or the fuel is thus carried out away from the regenerative-type burners 2a, 2b (FIG. 6), upstream thereof. In the regenerative burners 2a, 2b the energy transfer between the flue gases and the fluid to be preheated is carried out directly inside the burner, or in the immediate vicinity thereof, in a regenerator 3a, 3b formed by a compact mass of heat-accumulating materials.

In the exemplary embodiment shown, it is the combustion air that is preheated. This is conveyed from the fan 4 via the feed duct 5 to a feed nozzle 6, which distributes the air over four parallel circuits, each equipped with two successive two-pass exchangers. The preheated air is taken up, on leaving the recuperator, by a manifold 7, to be distributed to the burners 2a, 2b via the feed pipes 8. In the flue gas circuit, the flue B allows the flue gases extracted from the furnace 1 to be taken to the recuperator A where they cool, giving up heat to the combustion air, before they are discharged by the stack 9.

The operating principle of the regenerative burners will now be described in greater detail.

As shown in FIG. 6, the regenerative burners 2a, 2b are mounted in pairs on the furnace 1. The burners are installed on the opposed longitudinal walls of the furnace, facing each other in pairs. In turn, one of the burners of a pair serves as flue while the other heats.

Each burner contains a member 4a, 4b, formed in particular by a solenoid valve, which controls the intake of the fuel, a member 5a, 5b, in particular formed by a throttle valve, which controls the intake of the combustion air via a pipe 8, and a member 6a, 6b, in particular formed by a throttle valve, which allows the combustion gases to be discharged. It should be noted that one and the same member, for example a three-way valve, may provide the two functions of the members 5 and 6.

As shown in FIG. 6, when the burner 2b acts as flue, the exhaust member 6b is open and the air intake member 5b is closed. The combustion gases pass through the regenerator 3b and then discharge into the atmosphere, advantageously via an independent circuit as shown in FIG. 5, through the circuit 10 to the stack 11.

When the burner 2b is heating, the position of each member is reversed, and this time it is the combustion air that passes through the regenerator before being mixed with the fuel to be burnt.

Each burner therefore operates alternately in heater mode, with a cycle time composed of a heating phase and a flue phase of duration generally between 30 and 120 seconds. This time depends on the volume of the regenerator and on the calorific capacity that it is capable of accumulating, and also on other parameters that are not described here.

In the embodiment shown in FIG. 6, it is the combustion air that is preheated by passing through the regenerator. In another embodiment, it is the fuel that is preheated, by passing through the regenerator.

The power delivered by the burner in heater mode is adjusted according to the heat requirement in the furnace. A first adjustment mode consists in modulating the power of the burner by varying the fuel flow rate during its operating time in heater mode. Advantageously, the adjustment mode according to the invention consists in keeping the fuel flow rate constant and in modulating the operating time of the burner in heater mode.

1. Method of controlling a reheat furnace for reheating iron and steel products, for example slabs, blooms, ingots or billets, making it possible for the product to be reheated to be brought to the desired temperature for rolling, the furnace being equipped with a heat recuperator, wherein:
the furnace is equipped mostly with regenerative-type burners (2a, 2b) which include regenerators (3a, 3b) and operate in on/off mode;
the burners operate in time modulation mode;
a portion of the combustion gases passes through the regenerators of the regenerative burners so as to preheat one of the fluids (either the fuel or the oxidizer) participating in the combustion; and
the remainder of the combustion gases passes through the heat recuperator (A) placed outside the furnace in a flue (B) in order to preheat the fluid (either the oxidizer or the fuel) other than that preheated in the regenerators.

2. Method according to claim 1, wherein:
a lean gas is used exclusively as fuel; and
preheating to high temperature one of the fluids participating in the combustion, obtained as it flows through the regenerators (3a, 3b) of the burners, is combined with preheating of the other fluid participating in the combustion, obtained as it flows through the heat recuperator (A), and makes it possible for the products leaving the furnace to have been reheated to the required temperature.

3. Method according to claim 1, wherein the flow rate of the flue gases passing through the regenerator of a regenerative burner is determined so as to obtain the desired temperature of the flue gases leaving the regenerative burner and correspondingly the desired temperature of the fluid to be preheated after it has passed through the regenerator.

4. Method according to claim 1, wherein for a constant cycle time with switching between the two regenerative burners of any one pair of burners, the operating time of each regenerative burner in heater mode is adjusted for each cycle so that the burner transmits the required calorific value.

5. Method according to claim 1, wherein to achieve a sufficient flame temperature during the ignition phases of the furnace or when not operating at full capacity, the temperature of the fluid coming from the recuperator (A) is maintained at a minimum level, either by using the furnace burner(s) located closest to this recuperator or by using one or more booster burners.

6. Method according to claim 5 wherein the boosters burners are placed in the flue gas circuit upstream of the recuperator (A).

7. Method according to claim 1, wherein the proportion of flue gases passing through the heat recuperator (A) is advantageously used for precisely controlling the pressure inside the furnace, so as to limit the intake of air.

8. Method according to claim 2 wherein:
the lean gas is preheated in the regenerators of the burners to a temperature between 600° C. and 800° C.;
the lean gas has a calorific value of between 2700 kJ/Sm³ and 4000 kJ/Sm³; and
the oxidizer is formed by air preheated in the heat recuperator (A) to a temperature between 400° C. and 600° C. in order to obtain a flue gas temperature above 1300° C., allowing the product to be reheated to reach a temperature between 1150° C. and 1280° C.

9. Method according to claim 1, wherein the number of regenerative-type burners (2a, 2b) is greater than the total number of burners of another type.

10. Method according to claim 1, wherein the constant cycle time with switching between the two regenerative burners of any one pair of burners is between 40 and 80 seconds and the operating time of each regenerative burner in heater mode is adjusted for each cycle so that the burner transmits the required calorific value.

11. Reheat furnace for reheating iron and steel products, for example slabs, blooms, ingots or billets, making it possible for the product to be reheated to be brought to the desired temperature for rolling, which includes a heat recuperator, wherein it comprises:
on the one hand, mostly regenerative-type burners (2a, 2b) which include regenerators (3a, 3b) and operate in on/off mode;
means (4a, 5a; 4b, 5b) for making the burners (2a, 2b) operate in time modulation mode;
means (6a, 6b) so that a portion of the combustion gases passes through the regenerators (3a, 3b) of the regenerative burners so as to preheat one or other of the fluids participating in the combustion (either the fuel or the oxidizer); and
means (B) so that the remainder of the combustion gases passes through the heat recuperator (A) placed outside the furnace in a flue (B) for preheating the fluid (either the oxidizer or the fuel) that is not preheated in the regenerators.

12. Furnace according to claim 11, wherein the number of regenerative-type burners (2a, 2b) is greater than that of the other burners.
